(19) United States
(12) Patent Application Publication
(10) Pub. No.: US 2024/0211200 A1
(43) Pub. Date: Jun. 27, 2024

(54) LIVE PEER-TO-PEER VOICE COMMUNICATION SYSTEMS AND METHODS USING MACHINE INTELLIGENCE

(71) Applicant: Apple Inc., Cupertino, CA (US)

(72) Inventors: Robert D. Silfvast, Belmont, CA (US); Izzet B. Yildiz, Sunnyvale, CA (US); Daniel Javaheri Zadeh, San Jose, CA (US); Grant H. Mulliken, Los Gatos, CA (US); Srinath Nizampatnam, Milpitas, CA (US); Devin W. Chalmers, Oakland, CA (US)

(21) Appl. No.: 18/391,132

(22) Filed: Dec. 20, 2023

Related U.S. Application Data
(60) Provisional application No. 63/434,901, filed on Dec. 22, 2022.

(51) Int. Cl. G06F 3/16; G06F 3/01; H04S 7/00

(52) U.S. Cl. CPC G06F 3/165; G06F 3/013; G06F 3/014; H04S 7/303; H04S 2400/11; H04S 2400/13

(57) ABSTRACT

Various implementations disclosed herein include devices, systems, and methods that sense, assess, measure, or otherwise determine user attention to selectively transmit or deliver audio from an audio source (e.g., a talking user's voice captured by their device, a TV, etc.) to one or more listening users' devices and/or adjusts audio cancellation/transparency of environmental noise on the one or more listening users' devices in a multi-person setting.

### CROSS-REFERENCE TO RELATED APPLICATIONS

This application claims the benefit of U.S. Provisional Application Ser. No. 63/434,901 filed Dec. 22, 2022, which is incorporated herein in its entirety.

### TECHNICAL FIELD

The present disclosure generally relates to transmitting and/or presenting content via electronic devices, and in particular, to systems, methods, and devices that transmit and/or present audio and other types of content based on contextual factors such as user attention, user intention, environment, and spatial relationships.

### BACKGROUND

People frequently find themselves in environments that include sound conditions that are ill-suited for users. For example, a noisy environment that includes multiple sounds sources (e.g., people talking, televisions projecting sound, speakers playing music, etc.) may not be ideal for conversation between two people, requiring that that they raise their voices, move very close to one another, and/or expend effort ignoring the surrounding sounds. Similarly, a quiet environment such as a library may be so silent that two people must whisper from very close distances to avoid disturbing others. Existing electronic devices may not adequately help people in such environments to hear sounds from select sound sources and/or ensure that their own voices and sounds are heard by intended recipients.

### SUMMARY

Various implementations disclosed herein include devices, systems, and methods that use user attention to selectively send audio from an audio source (e.g., a talking user's voice captured by their device, a TV, etc.) to one or more listening users' devices and/or adjusts audio cancellation/transparency of environmental noise on the one or more listening users' devices in a given environment. Some implementations may address or minimize the “cocktail party effect” in which it takes user effort to focus on a talking person while ignoring background noise. Noise cancellation may exclude ambient sound while sound from desirable sources is provided via wireless sources. A listening user's attention to an audio source (e.g., TV, person talking, dance music, etc.) may be based on context, which, as examples, may be based on determining (a) object locations (e.g., whether a waiter has walked up to the user's table), (b) the listening person's eyes, head, speech cues, expressions, and gestures being indicative that they are listening to one or more sounds sources or not listening to one or more sound sources (c) who is talking to who, and/or (d) intended recipients of audio, e.g., based on the volume/whisper/other characteristics of the audio source. If a listener is attentive to another person at a noisy restaurant table, a connection may be selected to provide a 1:1 dedicated channel along with noise cancellation removing background noise and then, when the listener focuses on ambient/environment (e.g., the waiter walking up), ambient noise passthrough may be provided. Audio transmission may utilize a low-latency, multi-user wireless networking technology, such as data communication over an ultra-wideband (UWB) physical layer. The audio transmission may be considered low latency if the time required for communication is less than a threshold (e.g., less than 20 ms from user A device's microphone to user B device's speaker) or if the time required for wireless transmission is less than a threshold (e.g., less than 10 ms). A talker may be emphasized to a listening user, e.g., via highlighting, effects, blurring around the talker, to enable the listener to more easily associate sound that they hear with a person or object that they see. Conversely, a visual indication of to whom audio is being provided may be provided to the talking user, for example, to enable the talker to be better aware of who is listening or receiving the talker's audio.

In general, one innovative aspect of the subject matter described in this specification can be embodied in methods performed at a device having a processor. Such methods may obtain sensor data from one or more sensors in a physical environment that has at least one sound source. The sensor data may include image and/or sound data captured by a listening user's device and/or a talking user's device or a sensor on another device such as an audio source device, such as a tablet or television. The sensor data may include physiological sensor data, e.g., from either a talker's device or a listener's device, or both. The sensor data may include, but is not limited to, data regarding eye-tracking, pupil diameter, heart rate, respiratory rate, galvanic skin response, face/body temperature, neural data (EEG, fNIRS), and behavioral data (facial gestures, voice recognition). Obtaining the sensor data may involve obtaining images of a user's head (e.g., RGB and/or IR images), IMU data, depth sensing data from a depth sensor, IR flood light sensing, etc. Gesture data associated with detected hand or body movements (e.g., a user walking towards a sound source or jumping up and down) based on image analysis or an input device such as a watch).

Such methods may determine that an attention of a user (e.g., a listening user) of a second device is directed towards the audio source based on the sensor data. For example, this may involve decoding data about a time-varying auditory object of one's attention. In another example, this may involve a multimodal approach that uses eye position, head position, speech cues, and/or expressions. In accordance with determining that the attention of the user of the second device is directed towards the audio source, the methods may control provision of audio signal (e.g., audio data) from the audio source to the second device for audible presentation at the second device. For example, this may involve determining to send the data from the audio source and/or adjusting the volume of the audible presentation. The attention of the user may additionally or alternatively be used to control noise-cancellation or noise transparency at the second device. In some implementations, the techniques described herein may utilize the determined attention (e.g., attentive state) and a scene understanding (e.g., identification and location of objects within an environment) to determine how to transmit, adjust, or otherwise present audio via one or more electronic devices in an environment.

In some implementations, some of the methods disclosed herein obtains, with one or more sensors, physiological data (e.g., respiratory data, image data (facial, body, etc.), EEG amplitude, pupil modulation, eye gaze saccades, etc.) and behavioral signals (e.g., facial gestures based on image data, voice recognition based on acquired audio signals, etc.) associated with the user. Based on the obtained physiological data, some of the techniques described herein determine an attentive state during an experience. Physiological data, such as EEG amplitude/frequency, pupil modulation, eye gaze saccades, etc., and/or behavioral data can depend on the attentive state of an individual and characteristics of the scene in front of them. A physiological response and/or behavioral response can be obtained while using a device with eye tracking technology during an experience (e.g., a birthday party, a cocktail party, dinner at a restaurant, etc.). In some implementations, physiological response data can be obtained using other sensors, such as EEG sensors. Observing repeated measures of physiological response data to experiences can give insights about the underlying attentive state at different time scales.

Some implementations assess physiological data and other user information to help improve a user experience. In such processes, user preferences and privacy should be respected, as examples, by ensuring the user understands and consents to the use of user data, understands what types of user data are used, has control over the collection and use of user data and limiting distribution of user data, for example, by ensuring that user data is processed locally on the user's device, etc. Users should have the option to opt in or out with respect to whether their user data is obtained or used or to otherwise turn on and off any features that obtain or use user information. Moreover, each user should have the ability to access and otherwise find out anything that the system has collected or determined about them.

In accordance with some implementations, a non-transitory computer readable storage medium has stored therein instructions that are computer-executable to perform or cause performance of any of the methods described herein. In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates selective audio transmission and/or presentation in one context within an environment, in accordance with some implementations.

FIGS. 2A-2B illustrate selective audio transmission and/or presentation in various exemplary contexts within the environment of FIG. 1, in accordance with some implementations.

FIG. 3 illustrates selective audio transmission and/or presentation in another context within the environment of FIG. 1, in accordance with some implementations.

FIGS. 4A-C illustrate sharing of sound data in different ways based on context, in accordance with some implementations.

FIG. 5 is a flowchart representation of a method for selective audio transmission and/or presentation in accordance with some implementations.

FIG. 6 illustrates device components of an exemplary device in accordance with some implementations.

FIG. 7 illustrates an example head-mounted device (HMD) in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects or variants do not include all of the specific details described herein. Moreover, well-known systems, methods, components, devices and circuits have not been described in exhaustive detail so as not to obscure more pertinent aspects of the example implementations described herein.

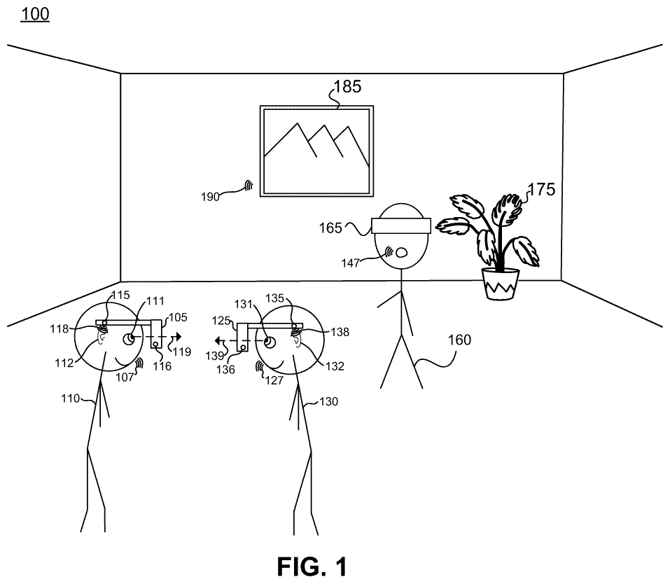

FIG. 1 illustrates a real-world physical environment 100 including a first user 110 wearing device 105, a second user 130 wearing device 125, a third user 160 wearing device 165, a television 185, and a plant 175. In some implementations, the devices 105, 125, 165 and television 185 are configured to communicate with one another (e.g., wirelessly) to provide one or more features. In one example, the devices 105, 125, 165 and television 185 form or are part of a system that employs live audio streaming amongst a group of users and devices within a physical environment 100, which may be a common noisy space or a quiet space. Such a system may provide features including, but not limited to, live voice streaming, selective communication/sharing, and/or artificial intelligence to ease or improve communications and other experiences amongst the group of users 110, 130, 160, etc. Wireless N-to-N networking technology with low latency may be used such that users do not readily perceive any delay between acoustic and electronic voice signals.

In some implementations, intelligent control algorithms are used, for example, to optimize how people within the system communicate, by dynamically: understanding via machine intelligence who is trying to talk to who, gating which paths in the communication/wireless network (e.g., a N-to-N network) are active at any given instant; and/or leveraging the network to distribute the machine intelligence amongst the multiple devices 105, 125, 165, television 185, and/or other devices, allowing decisions to be made based on aggregate information, e.g., sensor readings of states across some or all of the user.

Some implementations may facilitate the use of dynamic spatial audio rendering such that a given listener perceives each talker's audio or other sound source as if it were emanating from its current physical location.

Features may be provided using devices, sensors, and/or software modules that are sufficiently small in size and efficient with respect to power consumption and usage to fit and otherwise be used in lightweight, battery-powered, wearable products such as wireless ear buds or other ear-mounted devices or head mounted devices (HMDs) such as smart/augmented reality (AR) glasses. Features can be facilitated using a combination of multiple devices. For example, a smart phone (connected wirelessly and interoperating with wearable device(s)) may provide computational resources, connections to cloud or internet services, location services, etc.

In some implementations, audio sharing amongst a group of devices is enabled via speaker devices (e.g., integrated speakers in smart/AR glasses, headphones, earbuds, etc.) with active noise cancellation (ANC) and/or transparency modes.

In some implementations, ANC and/or transparency modes are controlled to block, limit, or pass external sounds from the physical environment 100, e.g., based on user attention to one or more audio sources and/or user intention to produce sound that will be heard by one or more other users. A given listener may hear audio from the only physical environment 100 (e.g., via full transparency mode), only transmitted audio (e.g., hearing audio of one or more other users talking that is captured by that one or more other user's device(s) and transmitted to the listener's device while other sounds of the physical environment 100 are reduced or excluded by ANC, etc.), or a combination of both audio from the physical environment 100 and transmitted audio. Moreover, the audio (e.g., via changes in transmissions, ANC, etc.) that the listener hears may change over time based on the context, e.g., based on the listener's attention, a talker's intention, and/or other characteristics of the physical environment (e.g., when the sensors detect that a waiter has walked up to the listener's dining table, etc.) changing over time.

In some implementations, devices 105, 125, 165 are head mounted devices (HMDs) that present visual and/or audio content (e.g., extended reality XR content) and/or have sensors that obtain sensor data (e.g., visual data, sound data, depth data, ambient lighting data, etc.) about the environment 100 or sensor data (e.g., visual data, sound data, depth data, physiological data, etc.) about the users 110, 130, 160.

In some implementations, the devices 105, 125, 165 obtain physiological data (e.g., EEG amplitude/frequency, pupil modulation, eye gaze saccades, etc.) from the users 110, 130, 160 via one or more sensors that are proximate or in contact with the respective user 110, 130, 160. For example, the device 105 may obtain pupillary data (e.g., eye gaze characteristic data) from an inward facing eye tracking sensor. In some implementations, the devices 105, 125, 165 include additional sensors for obtaining image or other sensor data of the physical environment 100.

In some implementations, the devices 105, 125, 165 are wearable devices such as ear-mounted speaker/microphone devices (e.g., headphones, ear pods, etc.), smart/AR glasses, and/or other head-mounted devices (HMDs). In some implementations, the devices 105, 125, 165 are handheld electronic devices (e.g., smartphones or tablets). In some implementations, the devices 105, 125, 165 are laptop computers or desktop computers. In some implementations, the devices 105, 125, 165 have input devices such as audio command input systems, gesture recognition-based input systems, touchpads and/or touch-sensitive displays (also known as a “touch screen” or “touch screen display”). In some implementations, multiple devices are used together to provide various features. For example, a smart phone (connected wirelessly and interoperating with wearable device(s)) may provide computational resources, connections to cloud or internet services, location services, etc.

In some implementations, a television 185 comprises multiple devices, e.g., a television display device and a set-top box or streaming device that connects to and provides content and/or connection between the system/network and the television display device. A television (display, set-top box, streaming device, etc.) includes one more sensors for determining characteristics of the physical environment 100, users 110, 130, 160 within the environment, and/or relative or absolute positioning of devices and/or users within the physical environment 100.

FIG. 1 illustrates an example in which the devices within the physical environment 100 include HMD devices 105, 125, 165 and a television 185. Numerous other types of devices may be used including mobile devices, tablet devices, wearable devices, hand-held devices, personal assistant devices, AI-assistant-based devices, smart speakers, desktop computing devices, menu devices, cash register devices, vending machine devices, juke box devices, and/or numerous other devices capable of presenting or capturing audio content and/or communicating with other devices within a system, e.g., via wireless communication.

In some implementations, the devices 105, 125, 165 (and/or television 185 or other devices) include eye tracking systems for detecting eye position and eye movements. For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, an illumination source on a device may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device. Additional cameras may be included to capture other areas of the user (e.g., an HMD with a jaw cam to view the user's mouth, a down cam to view the body, an eye cam for tissue around the eye, and the like). These cameras and other sensors can detect motion of the body, and/or signals of the face modulated by the breathing of the user (e.g., remote PPG).

In some implementations, the devices 105, 125, 165 (and/or television 185 or other devices) have graphical user interfaces (GUIs), one or more processors, memory and one or more modules, programs or sets of instructions stored in the memory for performing multiple functions. In some implementations, the users 110, 130, 160 may interact with a GUI through voice commands, finger contacts on a touch-sensitive surface, hand/body gestures, remote control devices, and/or other user input mechanisms. In some implementations, the functions include viewing/listening to content, image editing, drawing, presenting, word processing, website creating, disk authoring, spreadsheet making, game playing, telephoning, video conferencing, e-mailing, instant messaging, workout support, digital photographing, digital videoing, web browsing, digital music playing, and/or digital video playing. Executable instructions for performing these functions may be included in a computer readable storage medium or other computer program product configured for execution by one or more processors.

In some implementations, the devices 105, 125, 165 (and/or television 185 or other devices) employ various physiological and/or behavioral sensor, detection, or measurement systems. Detected physiological data may include, but is not limited to, EEG, electrocardiography (ECG), functional near infrared spectroscopy signal (fNIRS), blood pressure, skin conductance, or pupillary response. Detected behavioral data may include, but is not limited to, facial gestures based on image data, voice recognition based on acquired audio signals, etc.

In some implementations, the devices 105, 125, 165 (and/or television 185 or other devices) may be communicatively coupled to one or more additional sensors. For example, a sensor (e.g., an EDA sensor) may be communicatively coupled to a device 105, 125, 165 via a wired or wireless connection, and such a sensor may be located on the skin of the user (e.g., on the arm, placed on the hand/fingers of the user, etc.). For example, such a sensor can be utilized for detecting EDA (e.g., skin conductance), heart rate, or other physiological data that utilizes contact with the skin of a user. Moreover, a device 105, 125, 165 (using one or more sensors) may concurrently detect multiple forms of physiological data in order to benefit from synchronous acquisition of physiological data or behavioral data. Moreover, in some implementations, the physiological data or behavioral data represents involuntary data, e.g., responses that are not under conscious control. For example, a pupillary response may represent an involuntary movement. In some implementations, a sensor is placed on the skin as part of a watch device, such as a smart watch.

In some implementations, one or both eyes of a user, including one or both pupils of the user present physiological data in the form of a pupillary response (e.g., eye gaze characteristic data). The pupillary response of the user may result in a varying of the size or diameter of the pupil, via the optic and oculomotor cranial nerve. For example, the pupillary response may include a constriction response (miosis), e.g., a narrowing of the pupil, or a dilation response (mydriasis), e.g., a widening of the pupil. In some implementations, a device may detect patterns of physiological data representing a time-varying pupil diameter. In some implementations, the device may further determine the interpupillary distance (IPD) between a right eye and a left eye of the user.

The user data (e.g., upper facial feature characteristic data, lower facial feature characteristic data, and eye gaze characteristic data, etc.), including information about the position, location, motion, pose, etc., of the head and/or body of the user, may vary in time and a device 105, 125, 165 (and/or television 185 or other devices) may use the user data to improve the respective user's experience. In some implementations, the user data includes texture data of the facial features such as eyebrow movement, chin movement, nose movement, cheek movement, etc. For example, when a person (e.g., user 110, 130, 160) smiles (e.g., to detect a positively valenced event), the upper and lower facial features can include a plethora of muscle movements that used to assess the attention of a user in a given audio source based on the captured data from sensors.

The physiological data (e.g., eye data, head/body data, etc.) and behavioral data (e.g., voice, facial recognition, etc.) may vary in time and the device may use the physiological data and/or behavioral data to measure a physiological/behavioral response or the user's attention to an audio source and/or intention to talk to or produce other sounds for one or more particular intended recipients. For example, a listening user (e.g., one who is producing little or no sound) may be determined to be attentive to a particular talker or group of talkers based on which persons the listening user has directed a gaze towards in the last 30 seconds, 1 minute, or other period of time. In another example, such a listening user's attention may be alternatively or additionally assessed via an artificial intelligence-based or other machine learning-based model that predicts a user's attention based on sensor data from the user's device and/or other devices in the physical environment 100. In another example, a talking user's intention to be heard by one or more particular user's may be assessed by thresholds (e.g., distance between talker and potential listener, talker's volume, talker's gaze directions within a time period, etc.) or other algorithmic metrics and/or using an artificial intelligence-based or other machine learning-based model that predicts a user's intention to talk with certain listeners based on sensor data from the user's device and/or other devices in the physical environment 100. In some implementations, listeners and/or talkers provide explicit input (e.g., voice commands, gestures, etc.) to identify to whom they want to hear and/or be heard by. In some implementations, the attention and/or intentions of listeners and/or talkers are inferred based on predictions, e.g., via predictive models.

Information about such audio sharing predictions and how a user's own audio is shared may be provided to a user and the user given the option to opt out of automatic predictions/audio sharing of their own audio and given the option to manually override audio sharing determinations of their own audio. In some implementations, the system is configured to ensure that users' privacy is protected by requiring permissions to be mutually granted before audio sharing is enabled.

In the example of FIG. 1, each of the first user 110 and second user 130 is wearing a respective device 105, 125 configured with a respective speaker set 115, 135 (configured to provide audio 118, 138 near/on an ear 112, 132, respectively) and a sound capturing device set 116, 136, e.g., microphone, microphone array, beam-forming device, etc., positioned to capture speech or other sounds 107, 127 from a respective user 110, 130. The device 165 of the third user 160 may be similarly configured, e.g., with a sound capturing device set, e.g., microphone, microphone array, etc., positioned to capture speech or other sounds 147 from the third user 160 and/or a speaker set. The television 185, in this example, is configured to produce audio 190 in the physical environment 100.

In the example of FIG. 1, the first user 110 and the second user 130 are engaged in a conversation with one another, while neither first or second user 110, 130 is paying attention to the third user 160 or television 185. Sensors on the first user's device 105 (and/or the second user's device 125 or another device) may determine that the first user 110 is attentive to the second user 130 and not attentive to the third user 160 or television 185. For example, the first user's attention may be determined based on gaze direction 119 being directed towards the second user 130 at a given time or during a given time period such as during last 20 seconds while the first user 110 is not talking. Sensors on the second user's device 125 (and/or the first user's device 105 or other device) may determine that the second user 130 is producing audio (e.g., speech) that the second user 130 intends to be heard by the first user 110 (and not by the third user 160). For example, the second user's intentions may be determined based on gaze direction 139 being directed towards the first user 110 while the second user 130 is talking within a recent time window.

Based on one or both of the attention and/or intention determinations, a further determination may be made to transmit audio signal/data corresponding to the second user's produced audio 127 (e.g., speech captured by sound capturing device set 136) from the second device 125 to the first device 105, which uses the audio signal/data to reproduce the audio for the first user 110 to hear (e.g., via audio 118 produced by speaker set 115). Based on one or both of the attention and/or intention determinations, a further determination may be made to not transmit audio signal/data corresponding to the third user 160 or television 185.

Based on one or both of the attention and/or intention determinations, a further determination may be made to activate ANC or particular transparency mode on the first device 105 such that the first user 110 is better able to hear the audio signal/data received and used to reproduce the audio of the second user 130 captured by the second user's device 125 (e.g., without the potential distraction/sound competition from unwanted background noise from user 160, television 165, or otherwise in the physical environment 100).

The second user 130 may be able to talk at a normal or lower volume than may otherwise have been needed and/or maintain a greater distance from the first user given the ambient sounds in the physical environment 100, while still being heard by the first user 110. Moreover, the first user 110 may have a more desirable listening experience since they need not exert as much effort to tune out extraneous noise, avoiding the fatiguing “cocktail party effect,” in which a person's brain may become fatigued after drowning out unwanted noise and sounds over time.

Similarly, sensors on the second user's device 125 (and/or the first user's device 105 or other device) may determine that the second user 130 is attentive to the first user 110 and not attentive to the user 160 or television 185. For example, the second user's attention may be determined based on gaze direction 139 being directed towards the first user 110, e.g., while the second user 130 is not talking. Sensors on the first user's device 105 (and/or the second user's device 125 or other device) may determine that the first user 110 is producing audio (e.g., speech) that the first user 110 intends be heard by the second user 130. For example, the first user's intentions may be determined based on gaze direction 119 being directed towards the second user 130, while the first user 110 is talking.

Based on one or both of the attention and/or intention determinations, a further determination may be made to transmit audio signal/data corresponding to the first user's produced audio 107 (e.g., speech captured by sound capturing device set 116) from the first device 105 to the second device 125, which uses the audio signal/data to reproduce the audio for the second user 110 to hear (e.g., via audio 138 produced by speaker set 135).

Based on one or both of the attention and/or intention determinations, a further determination may be made to not transmit an audio signal/data corresponding to the third user 160 or television 185. Based on one or both of the attention and/or intention determinations, a further determination may be made to activate ANC or particular transparency mode on the second device 125 such that the second user 130 is better able to hear the audio reproduced from the first user's device 105 (e.g., without the potential distraction/sound competition from unwanted background noise from user 160, television 165, or otherwise in the physical environment 100).

The first user 110 may be enabled to talk at a normal or lower volume than may otherwise have been needed and/or a greater distance given the ambient sounds in the physical environment 100, while still being heard by the second user 130. Moreover, the second user 130 may have a more desirable listening experience since they need not exert as much effort to tune out extraneous noise. Implementations disclosed herein may facilitate conversations amongst two or more persons in noisy, crowded, or other environments in which it is otherwise undesirable or tiring to do so.

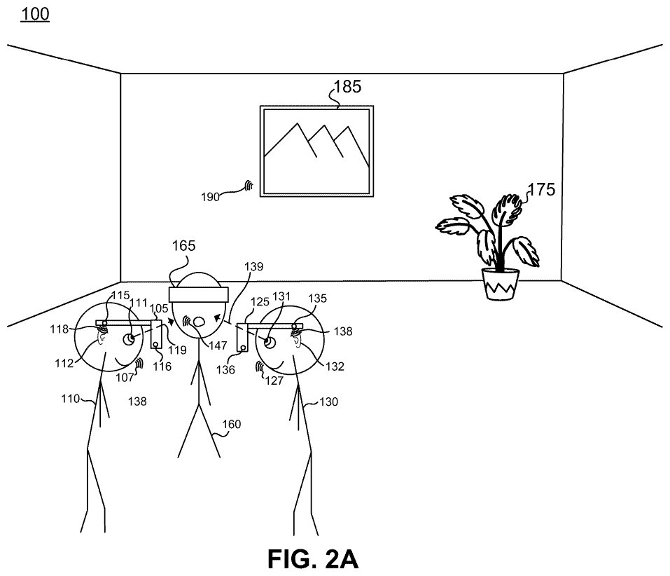

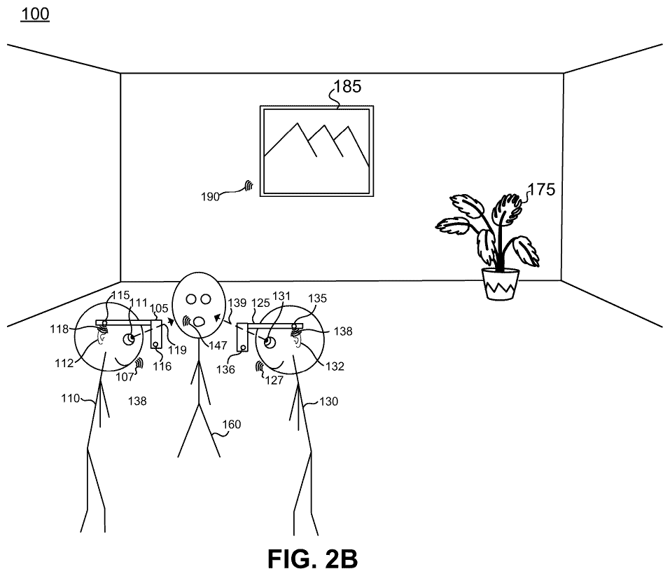

In the example, of FIG. 2A, the third user 160 has moved closer to participate in the conversation of the first and second users 110, 130. Each of the first, second, and third users 110, 130, 160 is attentive to the others in the group and intends to be heard by each of the other users in the group. However, none of the users 110, 130, 160 is attentive to the television 185.

Sensor data from one or more of the devices 105, 125, 165, 185 may be used to determine that the first user 110 is attentive to both the second user 130 and third user 160 (e.g., based on gaze direction 119 alternating between them) and not attentive to the television 185, that the second user 130 is attentive to the first user 110 and third user 160 (e.g., based on gaze direction 139 alternating between them) and not attentive to the television 185, and that the third user 160 is attentive to the first user 110 and second user 130 (e.g., based on their gaze direction alternating between them) and not attentive to the television 185. Sensor data from one or more of the devices 105, 125, 165, 185 may be used to determine that one or more of the users 110, 130, 160 is producing audio that the respective user intends to be heard by the other users in the group.

Based on the attention and/or intention determinations, a further determination may be made to transmit an audio signal/data corresponding any of the users 110, 130, 160 to the other users in the group and/or to not transmit an audio signal data corresponding to television 185.

Based on the attention and/or intention determinations, a further determination may be made to activate ANC or a particular/selected transparency mode on one or more of the devices 105, 125, 165 so that each of the users 110, 130, 160 is better able to hear audio produced by the other users in the group.

In the example, of FIG. 2B, the third user 160 has moved closer to participate in the conversation of the first and second users 110, 130. However, unlike in the scenario of FIG. 2A, the third user 160 is not wearing the third device 165. Each of the first, second, and third users 110, 130, 160 is attentive to the others in the group and intends to be heard by each of the other users in the group, but is not attentive to the television 185.

Sensor data from one or more of the devices 105, 125, 185 may be used to determine that the first user 110 is attentive to both the second user 130 and third user 160 and not attentive to the television 185, that the second user 130 is attentive to the first user 110 and third user 160 and not attentive to the television 185, and that the third user 160 is attentive to the first user 110 and second user 130 and not attentive to the television 185. Sensor data from one or more of the devices 105, 125, 185 may be used to determine that one or more of the users 110, 130, 160 is producing audio that the respective user intends to be heard by the other users in the group.

Based on the attention and/or intention determinations, a further determination may be made to deactivate ANC or activate particular transparency mode on one or more of the devices 105, 125, 165 so that each of the users 110, 130, 160 is better able to hear audio produced by the other users in the group via the ambient sounds in the physical environment. In this example, no audio signal/data is transmitted between the devices 105, 125. Alternatively, audio may be transmitted and played when available given device usage or other circumstances and supplemented/blended with transparent audio of the audio in the ambient environment, e.g., the second device blending audio produced from received audio signal/data of the first user's voice with ambient sound, including the third user's voice.

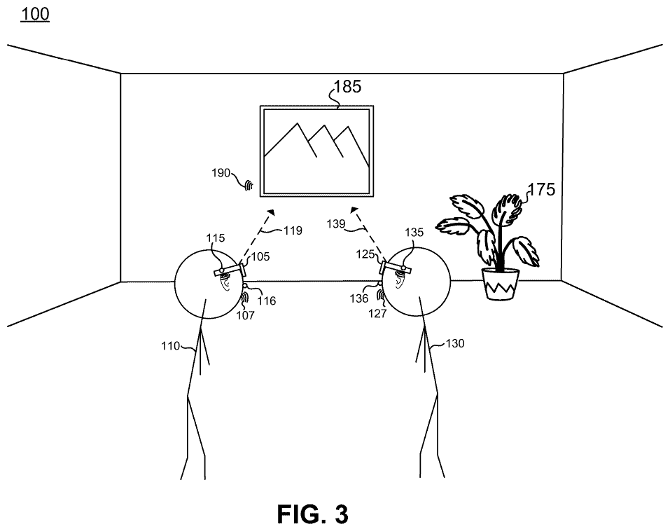

FIG. 3 illustrates selective audio transmission and/or presentation in another context. In this example, the third user 160 is no longer present and the first and second users 110, 130 are attentive to the television 185. Each of the first user 110 and second user 130, is also attentive to the other user and intends to be heard by the other user. Sensor data from one or more of the devices 105, 125, 185 may be used to determine that the first user 110 is attentive to both the second user 130 and the television 185 (e.g., based on gaze direction 119 alternating between them, etc.) and that the second user 130 is attentive to the first user 110 and the television 185 (e.g., based on gaze direction 139 alternating between them, etc.). Sensor data from one or more of the devices 105, 125, 185 may be used to determine that one or more of the users 110, 130 (or television 185) is producing audio that is intended to be heard by the first user 110 and second user 130.

Based on the attention and/or intention determinations, a further determination may be made to transmit an audio signal/data corresponding to audio 190 from the television 185 to the first and second users 110, 130, as well as to share any audio produced by the first and second user's 110, 130 with one another, e.g., via audio signal/data transmission. Based on the attention and/or intention determinations, a further determination may be made to activate ANC or particular transparency mode on one or more of the devices 105, 125, 165 so that each of the users 110, 130, 160 is better able to hear audio produced by the other users in the group.

In an alternative implementation, in the scenario of FIG. 3, ANC is disabled, a particular transparency mode is selected, and audio transmissions between devices 105, 125 and television 185 are not performed. In other words, the device 105, 125 may be adjusted to enable the users 110, 130 to hear the ambient noise in the physical environment 100, including the audio 190 produced by the television 185 and the audio 107, 127 produced by one another.

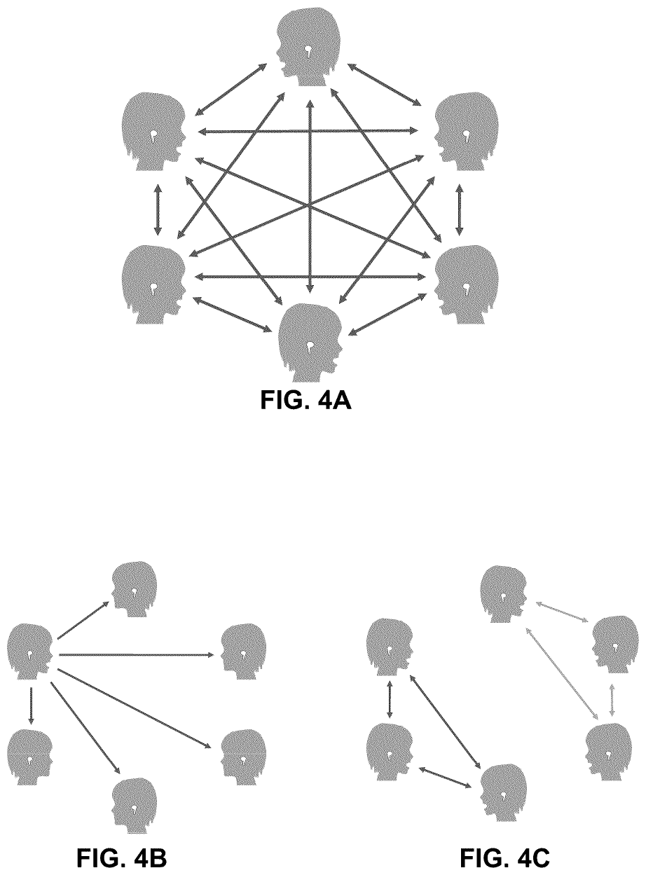

FIGS. 4A-C illustrate sharing of sound data in different ways based on context. In FIG. 4A, six people participate in a group conversation (e.g., during a team meeting) in which all participants are attentive to all others and, when producing audio, intend their own audio to be heard by all of the others in the group. Some implementations, detect such a scenario and facilitate sharing and/or transmission of audio signals/data amongst the group members accordingly, e.g., via a N-to-N transmission technique. In this scenario there are 30 possible data flows, which may consume a considerable bandwidth or other resources. In some implementations, transmission quantity is reduced by only transmitting noise data (e.g., compacting data transmissions to avoid transmitting silence). Some implementations detect circumstances in which the number and/or transmission of audio signals/data can be reduced based on user attention and/or intention.

In FIG. 4B, six people participate in a group conversation (e.g., a lecture) in which all participants are attentive to one particular talker. The listeners may not intend for their own audio to be heard by others in the group or want to hear audio from other listeners, e.g., during the lecture or presentation or until the presenter recognizes that another talker has the “floor”. Some implementations detect such a scenario and facilitate sharing and/or transmission of audio signals/data amongst the group members accordingly, e.g., via a 1-to-N transmission technique.

In FIG. 4C, six people participate in a group and are divided into subgroup conversations (e.g., cocktail party-like, social gathering-like groupings) in which all participants in each of the two subgroups are attentive to others in the respective subgroup and intend their own audio to be heard only by others in their own subgroups. Some implementations, detect such a scenario and facilitate sharing and/or transmission of audio signals/data amongst the sub-group members accordingly, e.g., via N-to-N transmission technique used for each of the sub-groups.

In some implementations, not all participants in a group conversation will have devices enabled to capture, play, transmit, or receive audio. In such cases, the transmission and/or ANC/transparency mode attributes may be adjusted according, for example, to ensure that participants without enabling technologies are still able to participate in the conversation, e.g., by listening and/or contributing sound.

Some implementations control one or more variables for each potential audio path in a group conversation, e.g., between every pair of participants. Such variables may include, but are not limited to, turning a given audio path on or off, adjusting the volume of an audio path, adjusting equalization or other audio characteristics of an audio path or the relative audio characteristics amongst the paths, altering a mode (e.g., earphone mode) for each user, controlling noise-cancelling/transparency, and/or blending transparency with wireless sources. The variables may be controlled based on user attention, user intention, and/or other relevant factors.

In some implementations, a 1-to-1 conversation is identified and a dedicated 1:1 channel is utilized. In some implementations, during a conversation, attention to ambient sounds is identified and an audio mix (e.g., transparency on plus audio from an audio channel of a conversation partner) is provided.

Some implementations decode time-varying information, e.g., regarding people and audio objects to which people are attentive. Some implementations utilize a multimodal approach, e.g., using eye position, head position, speech cues, expressions, etc. Some implementations enable seamless control of the level and characteristics of different sound sources that a user may or may not be attended to at a particular moment or time period.

In some implementations, audio is enhanced with spatialized audio (e.g., listeners perceiving sounds as if they are emanating from the respective direction from each person/sound source) and/or volume modulation based on who is talking to who (e.g., not everyone in a group conversation has to hear the talker at the same level).

It may provide the ability to easily control sound capture/microphone, hands free, or otherwise improve user input, e.g., enabling/disabling mic (mute/unmute), steer sound capture to another direction instead of the talker's mouth (e.g., listen to my niece singing a song), etc.

It may facilitate a PA equivalent system, e.g., in a lecture hall, via multi-cast. In such a scenario and others, any person (audience member) can become a source to ask a question or otherwise contribute audio.

Some implementations use security and encryption measures to enhance privacy, for example, by enabling people to talk more quietly (e.g., which may be facilitated by providing the sound to the listener as well as the talker to provide amplified feedback to the talker). Such privacy may be useful in various environments including, but not limited to, noisy and environments as well as public spaces that are not noisy, e.g., libraries, doctor offices, etc. Some implementations provide indications or otherwise enable users to be better away of who is listening/eavesdropping.

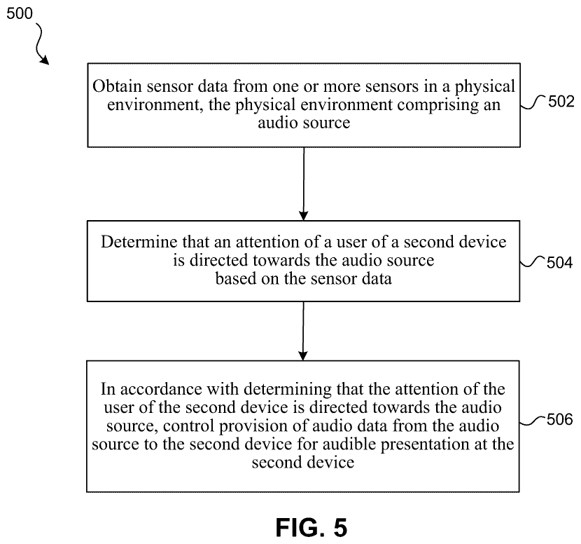

FIG. 5 is a flowchart representation of a method for selective audio transmission and/or presentation in accordance with some implementations. In some implementations, a device such as one or more of devices 105, 125, 165, 185 (FIG. 1) performs the techniques of method 500 based on determining an attentive state and/or a scene understanding of a physical environment. In some implementations, the techniques of method 500 are performed on a mobile device, desktop, laptop, HMD, wearable device, or server device. In some implementations, the method 500 is performed on processing logic, including hardware, firmware, software, or a combination thereof. In some implementations, the method 500 is performed on a processor executing code stored in a non-transitory computer-readable medium (e.g., a memory). The method 500 may be performed by a first devices that is the same as or different than a second device that is being used by a user.

At block 502, the method 700 obtains sensor data from one or more sensors in a physical environment that includes an audio source. In some implementations, the sensor data corresponds to physiological data and may include EEG amplitude/frequency, image data of the user's face, pupil modulation, eye gaze saccades, EDA, heart rate, and the like. For example, obtaining the sensor data may involve obtaining images of the eye or EOG data from which gaze direction/movement can be determined, electrodermal activity/skin conductance, heart rate, via sensors on a watch (e.g., sensor).

The one or more sensors (e.g., physiological sensors, behavioral sensors, etc.) may include sensors on a device worn by the user (e.g., sensor, such as an EDA sensor on the back of a watch). The obtained physiological data or behavioral data may include measuring gaze (such as eye gaze stability) because, in the context of tracking attentive states, gaze direction and gaze direction changes over time may be indicative of the user's attention.

In some implementations, the sensor data corresponds to or used to determine behavioral data that may include behavioral signals such as facial gestures based on image data (e.g., via internal facing cameras on an HMD), voice recognition based on acquired audio signals, hand gestures, and the like. Additionally, facial data may be included as behavioral data (e.g., reconstruction of the user's face based on obtained image data via an internal facing camera on a device, such as an HMD, or image date obtained from another source).

In some implementations, physiological data and/or behavioral data may be based on hand gesture data associated with detected hand or body movements based on image analysis or an input device such as a watch or other sensor data. For example, a user may be determined to have a particular attentive state based on the actions of a user (e.g., a user pointing at something or someone, touching another person or object, walking towards another person or object, jumping up and down in an excited state, nodding in sync with the rhythm, beat, or cadence of the speech of another person or music/sound in the environment, etc.).

In some implementations, the sensor data includes image data such as light intensity image data and/or depth data from one or more depth sensors (e.g., a structured light, a time-of-flight, or the like) of the physical environment. In some implementations, the sensor data includes location data of the user (e.g., user 110) and/or the device (e.g., device 105).

In some implementations, a context or characteristic (e.g., loudness, crowdedness, number of audio sources, etc.) of an environment is determined based on sensor data from the one or more sensors. For example, identifying a context of the scene may determine that a user is at a birthday party (e.g., a birthday cake is identified), a sporting event (e.g., a scoreboard for a game is identified), a restaurant (e.g., based on identifying tables, menus, etc.), a cocktail party (e.g., based on groupings of standing people, etc.). Additionally, or alternatively, a context may be based on accessing a calendar application (e.g., the user is scheduled to be at a party at the current time).

In some implementations, the method 500 determines a context based on sensor data of the environment. For example, determining a context may involve using computer vision to generate a scene understanding of the visual and/or auditory attributes of the environment—where is the user, what is the user doing, what objects are nearby. Additionally, a scene understanding of the content presented to the user could be generated that includes the visual and/or auditory attributes of what the user was watching. In some aspects, different contexts of content presented and the environment are analyzed to determine where the user is, what the user is doing, what objects or people are nearby in the environment or within the content, what the user did earlier (e.g., meditated in the morning), etc. Additionally, context analysis may include image analysis (semantic segmentation), audio analysis (jarring sounds), location sensors (where user is), motion sensors (fast moving vehicle), and even access other user data (e.g., a user's calendar). In an exemplary implementation, the method 500 may further include determining the context by generating a scene understanding of the environment based on the sensor data of the environment, the scene understanding including visual or auditory attributes of the environment and determining the context based on the scene understanding of the environment.

At block 504, the method 500 determines that an attentive state of a user of a second device is directed towards the audio source based on the sensor data. Determining that the attention of a user of the second device is directed towards the audio source may involve determining a location or movement of an object in the physical environment based one or more images of the sensor data. Determining that the attention of a user of the second device is directed towards the audio source may be based on determining that the user is listening to a second user talking based on the sensor data. The attention of the user of the second device being directed towards the audio source may be determined based on sensor data obtained by the first device, the second device, and/or another device and such determination may be made at the first device, the second device and/or another device. In one example, a talker's device captures sensor data of its environment including of a listener and uses the sensor data to determine whether the listener is listening to the talker. In another example, a listener's device captures sensor data from which a talker is identified and from which it can determine that the listener is attentive to the talker.

Determining that the attention of a user of the second device is directed towards the audio source may be based on an image or depth sensor data of the physical environment captured by the device, second device, or the audio source, an image or depth sensor data of an eye of the user captured by the device, second device, or the audio source, an image or depth sensor data of a head of the user captured by the device, second device, or the audio source, and/or physiological data of the user captured by the device. Determining that the attention of a user of the second device is directed towards the audio source may be based on tracking eye position, gaze direction, or pupillary response of the user, tracking a head position or head movement of the user, determining a facial expression exhibited by the user and/or detecting a movement of the user based on detecting a movement of the second device, for example, where the second device is worn by the user.

The attention of the user may identify to which persons or sound-producing objects within a physical environment a user is currently (e.g., within the last 5 seconds, 10 seconds, 20 seconds, 1 minute, 5 minutes, etc.) attentive. In some implementations, a machine learning model may be used to determine the attentive state based on physiological data, and audio/visual content of the experience and/or the environment. For example, one or more physiological characteristics may be determined, aggregated, and used to classify the attentive state using statistical or machine learning techniques. In some implementations, the response may be compared with the user's own prior physiological responses or typical user physiological responses to similar content of a similar experience and/or similar environment attributes.

In some implementations, attentive state may include a motion state (e.g., a stationary state, a moving state, etc.).

In some implementations, obtaining the sensor data is associated with a physiological response of the user corresponding to a response or lack of response to an activity or sound presented by a person or sound source, e.g., within a predetermined time of a touchdown occurring on a television, within a predetermined time following another person approaching or entering a predetermined distance of the user, etc. For example, the system may wait for up to five seconds after a waiter walks close to a user to see if the user looks in the particular direction (e.g., a physiological response) of the waiter.

In some implementations, obtaining physiological data (e.g., pupillary data) is associated with a gaze of a user that may involve obtaining images of the eye or electrooculography signal (EOG) data from which gaze direction and/or movement can be determined. In some implementations, the physiological data includes at least one of skin temperature, respiration, photoplethysmogram (PPG), electrodermal activity (EDA), eye gaze tracking, and pupillary movement that is associated with the user.

Determining that the attention of a user of the second device is directed towards the audio source may involve determining an intended recipient of audio of the audio source. The intended recipient may be determined based on a volume of the audio source, e.g., a whisper may indicate an intention to only be heard by nearby users while a shout may indicate an intention to be heard by a larger group of people or an entire environment. Similarly, use of a microphone or other sound amplification device may indicate an intention to be heard by more people than otherwise.

User preferences and privacy should be respected, as examples, by ensuring the user understands and consents to the use of user data, understands what types of user data are used, has control over the collection and use of user data and limiting distribution of user data, for example, by ensuring that user data is processed locally on the user's device. Users should have the option to opt in or out with respect to whether their user data is obtained or used or to otherwise turn on and off any features that obtain or use user information. Moreover, each user will have the ability to access and otherwise find out anything that the system has collected or determined about him or her. User data is stored securely on the user's device. User data that is used as input to a machine learning model is stored securely on the user's device, for example, to ensure the user's privacy. The user's device may have a secure storage area, e.g., a secure enclave, for securing certain user information, e.g., data from image and other sensors that is used for face identification, face identification, or biometric identification. The user data associated with the user's body and/or attentive state may be stored in such a secure enclave, restricting access to the user data and restricting transmission of the user data to other devices to ensure that the user data is kept securely on the user's device. User data may be prohibited from leaving the user's device and may be used only in machine learning models and other processes on the user's device.

In some implementations, the attentive state may be determined based on using physiological data to determine head pose, body pose, sounds, jaw movement, cheek movement, nose movement, movement of tissue surrounding an eye, or a signal of a face modulated by breath (e.g., PPG). For example, a determined respiratory rate may be approximately 7 breaths per minute. In some implementations, determining a respiratory rate may involve sensor fusion of different acquired data without using an additional respiratory sensor. For example, the different acquired data that may be fused may include head pose data from an IMU, audio from a microphone, camera images of the user's face and/or body (e.g., an HMD with a jaw cam, down cam, eye cam for tissue around the eye, and the like), motion of the body, and/or signal of the face modulated by the breath (e.g., remote PPG). Using this type of sensor fusion to track the breathing of the user, such as while wearing an HMD, may negate the need for a user to wear a sensor worn around the user's diaphragm, for example, to track his or her respiratory rates.

In some implementations, an attentive state may be determined based on obtained physiological data and the context of the experience. A machine learning model may be used, for example, in which sensor data are input into the machine learning model to identify one or more one or more user attentive state characteristics and/or objects of user attention. For example, a machine learning model may be used to determine the attentive state based on eye tracking and other physiological data, behavioral data, and audio/visual content of the experience and/or the environment (e.g., a scene understanding). For example, one or more physiological or behavioral characteristics may be determined, aggregated, and used to classify the attentive state using statistical or machine learning techniques. In some implementations, the response may be compared with the user's own prior responses or typical user responses to similar content of a similar experience and/or similar environment attributes.

In some implementations, the attentive state is determined based on using the physiological data to measure gaze or body stability. In some implementations, the attentive state is determined based on determining a level of emotion (e.g., a Differential Emotions Scale (DES), a Levels of Emotional Awareness Scale (LEAS), and the like). In some implementations, the attentive state is determined based on the respiratory state (e.g., a particular range of a respiratory rate may indicate the user is focused on a task).

In some implementations, determining that the user has a particular threshold of attention (e.g., high, low, etc.) includes determining a level of attention as a sliding scale. For example, the system could determine a level of attention as an attention barometer that can be customized based on the environment, e.g., number of sound sources, volume of total noise in the environment, etc.

In some implementations, an attentive state may be determined by using statistical or machine learning-based classification techniques. For example, determining that the user has an attentive state may include using a machine learning model trained using ground truth data that includes self-assessments in which users labelled portions of experiences with attentive state labels. For example, to determine the ground truth data that includes self-assessments, a group of subjects, while participating in various social scenarios, could be prompted at different time intervals (e.g., every 30 seconds) to label their own attentive state.

In some implementations, one or more pupillary or EEG characteristics may be determined, aggregated, and used to classify the attentive state using statistical or machine learning techniques. In some implementations, the physiological data is classified based on comparing the variability of the physiological data to a threshold. For example, if the baseline for a user's EEG data is determined during an initial segment of time (e.g., 30-60 seconds), and during a subsequent segment of time following an auditory stimulus (e.g., 5 seconds) the EEG data deviates more than +/−10% from the EEG baseline during the subsequent segment of time, than the techniques described herein could classify the user as transitioned away from one attentive state and entered a second attentive state. Similarly, the heart rate data and/or EDA data may also be classified based on comparing the variability of the heart rate data and/or EDA data to a particular threshold.

At block 506, in accordance with determining that the attention of the user of the second device is directed towards the audio source, the method 500 controls provision of audio signals/data from the audio source to the second device for audible presentation at the second device. Controlling the provision of audio signals/data from the audio source to the second device may involve determining to transmit the audio signals/data from the audio source to the second device based on the attention of the user of the second device being directed towards the audio source. Some implementations utilize a network that has a latency that is below a threshold such as 60 ms, 40 ms, or 20 ms. Some implementations utilize an N-to-N network topology in which N is greater than 1, rather than using point-to-point links. Other implementations utilize a point-to-point topology, e.g., in which N could be 1. The audio signals/data may be sent from the audio source to the second device via an ultra-wide (UW) band connection, e.g., an UW, low latency, N-to-N, ad hoc connection.

Controlling the provision of audio signals/data from the audio source to the second device may involve adjusting a volume of the audible presentation of the audio based on the attention of the user of the second device being directed towards the audio source.

Controlling the provision of audio signals/data from the audio source to the second device may involve enabling noise cancellation (e.g., ANC) or a particular transparency mode at the second device based on the attention of the user of the second device being directed towards the audio source.

In some implementations, the method 500 detects a change in the attention of the user of the second device and, in accordance with detecting the change in the attention of the user, changes provision of the audio signal/data from the audio source to the second device and/or discontinues or reduces noise cancelation provided via the second device.

In some implementations, the method 500 determines that the user is having difficulty hearing the audio source based on the sensor data and, in accordance with determining that the user is having difficulty hearing the audio source, controls provision of audio signals/data from the audio source to the second device for audible presentation at the second device.

In some implementations, the method 500 provides an indication to a talker (or any other sound producing person) notifying the talker of to whom their audio signals/data is being transmitted. For example, an HMD may show a view of a physical environment with visual augmentations that identify the people that are being provided the audio signals/data.

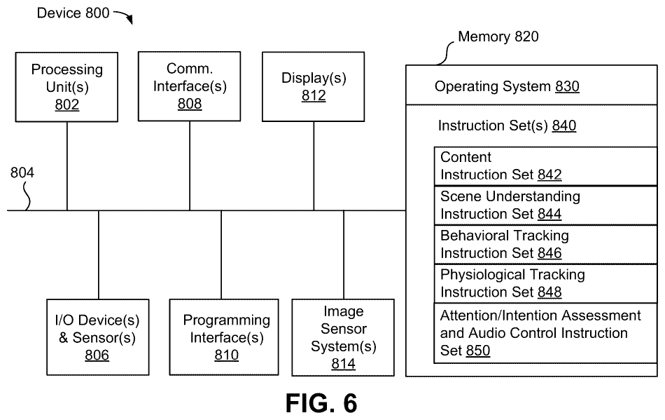

FIG. 6 is a block diagram of an example device 800. Device 800 illustrates an exemplary device configuration for device 105, device 125, device 165, television 185, or any other device used in accordance with one or more of the techniques disclosed herein. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 800 includes one or more processing units 802 (e.g., microprocessors, ASICs, FPGAs, GPUs, CPUs, processing cores, and/or the like), one or more input/output (I/O) devices and sensors 806, one or more communication interfaces 808 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 810, one or more displays 812, one or more interior and/or exterior facing image sensor systems 814, a memory 820, and one or more communication buses 804 for interconnecting these and various other components.

In some implementations, the one or more communication buses 804 include circuitry that interconnects and controls communications between system components. In some implementations, the one or more I/O devices and sensors 806 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 812 are configured to present a view of a physical environment or a graphical environment to the user. In some implementations, the one or more displays 812 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 812 correspond to diffractive, reflective, polarized, holographic, etc. waveguide displays. In one example, the device 800 includes a single display. In another example, the device 800 includes a display for each eye of the user.

In some implementations, the one or more image sensor systems 814 are configured to obtain image data that corresponds to at least a portion of the physical environment 100. For example, the one or more image sensor systems 814 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 814 further include illumination sources that emit light, such as a flash. In various implementations, the one or more image sensor systems 814 further include an on-camera image signal processor (ISP) configured to execute a plurality of processing operations on the image data.

The memory 820 includes high-speed random-access memory, such as DRAM, SRAM, DDR RAM, or other random-access solid-state memory devices. In some implementations, the memory 820 includes non-volatile memory, such as one or more magnetic disk storage devices, optical disk storage devices, flash memory devices, or other non-volatile solid-state storage devices. The memory 820 optionally includes one or more storage devices remotely located from the one or more processing units 802. The memory 820 includes a non-transitory computer readable storage medium.

In some implementations, the memory 820 or the non-transitory computer readable storage medium of the memory 820 stores an optional operating system 830 and one or more instruction set(s) 840. The operating system 830 includes procedures for handling various basic system services and for performing hardware dependent tasks. In some implementations, the instruction set(s) 840 include executable software defined by binary information stored in the form of electrical charge. In some implementations, the instruction set(s) 840 are software that is executable by the one or more processing units 802 to carry out one or more of the techniques described herein.

The instruction set(s) 840 include a content instruction set 842, a scene understanding instruction set 844, a behavioral tracking instruction set 846, a physiological tracking instruction set 848, and an attention and/or intention assessment and audio control instruction set 850. The instruction set(s) 840 may be embodied a single software executable or multiple software executables.

In some implementations, the content instruction set 842 is executable by the processing unit(s) 802 to provide and/or track content for display on a device. The content instruction set 842 may be configured to monitor and track the content over time (e.g., during an experience such as an education session) and/or to identify change presented audio and/or visual content. In some implementations, the scene understanding instruction set 844 is executable by the processing unit(s) 802 to determine a context of the experience and/or the environment (e.g., create a scene understanding to determine the objects or people in the content or in the environment, where the user is, what the user is doing, etc.) using one or more of the techniques discussed herein (e.g., object detection, facial recognition, etc.) or as otherwise may be appropriate. In some implementations, the behavioral tracking instruction set 846 is executable by the processing unit(s) 802 to tracking activity of one or more users using one or more of the techniques discussed herein or as otherwise may be appropriate. In some implementations, the physiological tracking instruction set 848 is executable by the processing unit(s) 802 to track a user's physiological attributes (e.g., EEG amplitude/frequency, pupil modulation, eye gaze saccades, heart rate, EDA data, etc.) using one or more of the techniques discussed herein or as otherwise may be appropriate. In some implementations, the attention and/or intention assessment and recording instruction set 850 is executable by the processing unit(s) 802 to assess the attention and/or intention of users based on physiological data (e.g., eye gaze response), behavioral data, and context data of the content and/or environment using one or more of the techniques discussed herein or as otherwise may be appropriate. To these ends, in various implementations, the instruction includes instructions and/or logic therefor, and heuristics and metadata therefor.

Although the instruction set(s) 840 are shown as residing on a single device, it should be understood that in other implementations, any combination of the elements may be located in separate computing devices. Moreover, FIG. 8 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

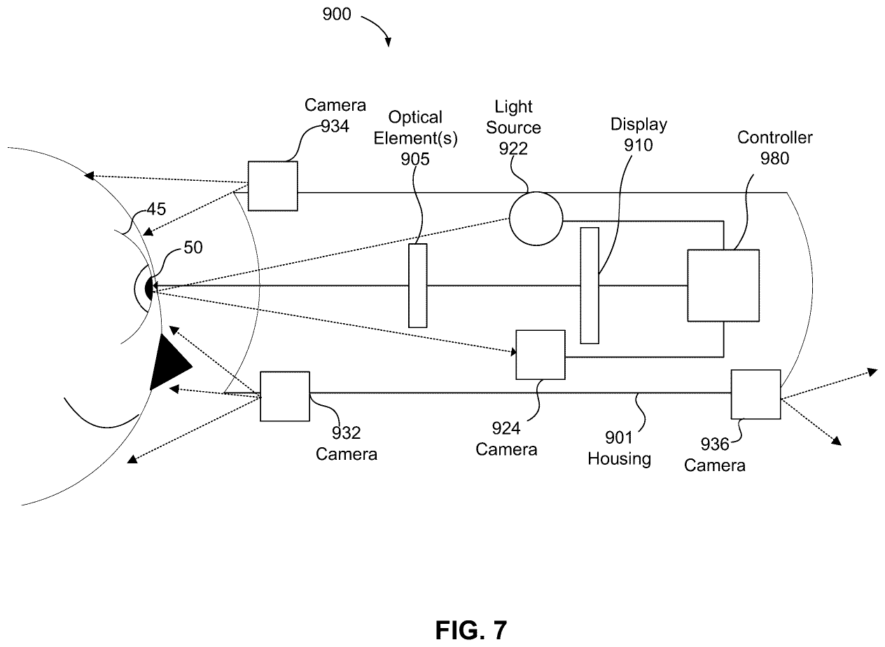

FIG. 7 illustrates a block diagram of an exemplary head-mounted device 900 in accordance with some implementations. The head-mounted device 900 includes a housing 901 (or enclosure) that houses various components of the head-mounted device 900. The housing 901 includes (or is coupled to) an eye pad (not shown) disposed at a proximal (to the user 110) end of the housing 901. In various implementations, the eye pad is a plastic or rubber piece that comfortably and snugly keeps the head-mounted device 900 in the proper position on the face of the user 110 (e.g., surrounding the eye 45 of the user 110).

The housing 901 houses a display 910 that displays an image, emitting light towards or onto the pupil 50 of an eye 45 of a user 110. In various implementations, the display 910 emits the light through an eyepiece having one or more optical elements 905 that refracts the light emitted by the display 910, making the display appear to the user 110 to be at a virtual distance farther than the actual distance from the eye to the display 910. For example, optical element(s) 905 may include one or more lenses, a waveguide, other diffraction optical elements (DOE), and the like. For the user 110 to be able to focus on the display 910, in various implementations, the virtual distance is at least greater than a minimum focal distance of the eye (e.g., 7 cm). Further, in order to provide a better user experience, in various implementations, the virtual distance is greater than 1 meter.

The housing 901 also houses a tracking system including one or more light sources 922, camera 924, camera 932, camera 934, camera 936, and a controller 980. The one or more light sources 922 emit light onto the eye of the user 110 that reflects as a light pattern (e.g., a circle of glints) that can be detected by the camera 924. Based on the light pattern, the controller 980 can determine an eye tracking characteristic of the user 110. For example, the controller 980 can determine a gaze direction and/or a blinking state (eyes open or eyes closed) of the user 110. As another example, the controller 980 can determine a pupil center, a pupil size, or a point of regard associated with the pupil 50. Thus, in various implementations, the light is emitted by the one or more light sources 922, reflects off the eye of the user 110, and is detected by the camera 924. In various implementations, the light from the eye of the user 110 is reflected off a hot mirror or passed through an eyepiece before reaching the camera 924.

The display 910 emits light in a first wavelength range and the one or more light sources 922 emit light in a second wavelength range. Similarly, the camera 924 detects light in the second wavelength range. In various implementations, the first wavelength range is a visible wavelength range (e.g., a wavelength range within the visible spectrum of approximately 400-700 nm) and the second wavelength range is a near-infrared wavelength range (e.g., a wavelength range within the near-infrared spectrum of approximately 700-1400 nm).

In various implementations, eye tracking (or, in particular, a determined gaze direction) is used to enable user interaction (e.g., the user 110 selects an option on the display 910 by looking at it), provide foveated rendering (e.g., present a higher resolution in an area of the display 910 the user 110 is looking at and a lower resolution elsewhere on the display 910), or correct distortions (e.g., for images to be provided on the display 910).

In various implementations, the one or more light sources 922 emit light towards the eye of the user 110 which reflects in the form of a plurality of glints.

In various implementations, the camera 924 is a frame/shutter-based camera that, at a particular point in time or multiple points in time at a frame rate, generates an image of the eye of the user 110. Each image includes a matrix of pixel values corresponding to pixels of the image which correspond to locations of a matrix of light sensors of the camera. In implementations, each image is used to measure or track pupil dilation by measuring a change of the pixel intensities associated with one or both of a user's pupils.

In various implementations, the camera 924 is an event camera including a plurality of light sensors (e.g., a matrix of light sensors) at a plurality of respective locations that, in response to a particular light sensor detecting a change in intensity of light, generates an event message indicating a particular location of the particular light sensor.

In various implementations, the camera 932, camera 934, and camera 936 are frame/shutter-based cameras that, at a particular point in time or multiple points in time at a frame rate, can generate an image of the face of the user 110 or capture an external physical environment. For example, camera 932 captures images of the user's face below the eyes, camera 934 captures images of the user's face above the eyes, and camera 936 captures the external environment of the user (e.g., environment 100 of FIG. 1). The images captured by camera 932, camera 934, and camera 936 may include light intensity images (e.g., RGB) and/or depth image data (e.g., Time-of-Flight, infrared, etc.).

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of physiological data to improve a user's experience of an electronic device with respect to interacting with electronic content. The present disclosure contemplates that in some instances, this gathered data may include personal information data that uniquely identifies a specific person or can be used to identify interests, traits, or tendencies of a specific person. Such personal information data can include physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve interaction and control capabilities of an electronic device. Accordingly, use of such personal information data enables calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access his or her stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various objects, these objects should not be limited by these terms. These terms are only used to distinguish one object from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “or” as used herein refers to and encompasses any and all possible combinations of one or more of the associated listed items. It will be further understood that the terms “comprises” or “comprising,” when used in this specification, specify the presence of stated features, integers, steps, operations, objects, or components, but do not preclude the presence or addition of one or more other features, integers, steps, operations, objects, components, or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at a first device having a processor:
obtaining sensor data from one or more sensors in a physical environment, the physical environment comprising an audio source; determining that an attention of a user of a second device is directed towards the audio source based on the sensor data; and
in accordance with determining that the attention of the user of the second device is directed towards the audio source, controlling provision of an audio signal from the audio source to the second device.

2. The method of claim 1, wherein controlling the provision of audio signal from the audio source to the second device comprises determining to transmit the audio signal from the audio source to the second device based on the attention of the user of the second device being directed towards the audio source.

3. The method of claim 2, wherein the audio signal is transmitted from the audio source to the second device via a low latency, wireless link.

4. The method of claim 1, wherein the audio signal is transmitted from the audio source to multiple devices via a 1 to N network topology.

5. The method of claim 1, wherein the audio signal is transmitted from the audio source to multiple devices via an N to N network topology comprising multiple devices that share audio information with one another selectively based on attention of users of the multiple devices.

6. The method of claim 1, wherein controlling the provision of audio signal from the audio source to the second device comprises adjusting a volume of the audible presentation of the audio signal from the audio source to the second device based on the attention of the user of the second device being directed towards the audio source.

7. The method of claim 1, wherein controlling the provision of audio signal from the audio source to the second device comprises enabling noise cancellation at the second device based on the attention of the user of the second device being directed towards the audio source.

8. The method of claim 1, wherein controlling provision of audio signal from the audio source to the second device comprises enabling a spatialized rendering of audio based on the audio signal based on a position of the audio source.

9. The method of claim 1 further comprising:
detecting a change in the attention of the user of the second device; and
in accordance with detecting the change in the attention of the user, changing provision of the audio signal from the audio source to the second device.

10. The method of claim 9, wherein:
detecting the change in the attention of the user comprises detecting that the attention of the user of the second device is directed to an object in the physical environment separate from the audio source; and
in accordance with detecting that the attention of the user of the second device is directed to the object, discontinuing or reducing noise cancelation provided via the second device.

11. The method of claim 1, wherein determining that the attention of a user of the second device is directed towards the audio source comprises determining a location or movement of an object in the physical environment based one or more images of the sensor data.

12. The method of claim 1, wherein determining that the attention of a user of the second device is directed towards the audio source comprises determining, based on the sensor data, that the user is listening to the audio source and the audio source is a second user talking.

13. The method of claim 1, wherein determining that the attention of a user of the second device is directed towards the audio source comprises determining an intended recipient of audio of the audio source.

14. The method of claim 13, wherein the intended recipient is determined based on a volume of the audio source.

15. The method of claim 1, wherein determining that the attention of a user of the second device is directed towards the audio source is based on:
an image or depth sensor data of the physical environment captured by the device, second device, or the audio source.

16. The method of claim 1, wherein determining that the attention of a user of the second device is directed towards the audio source is based on:
an image or depth sensor data of an eye of the user captured by the device, second device, or the audio source;
an image or depth sensor data of a head of the user captured by the device, second device, or the audio source; or
physiological data of the user captured by the device.

17. The method of claim 1, wherein determining that the attention of a user of the second device is directed towards the audio source comprises tracking eye position, gaze direction, or pupillary response of the user.

18. The method of claim 1, wherein determining that the attention of a user of the second device is directed towards the audio source comprises tracking a head position or head movement of the user.

19. The method of claim 1, wherein determining that the attention of a user of the second device is directed towards the audio source comprises:
determining a facial expression exhibited by the user; or
detecting a movement of the user based on detecting a movement of the second device, wherein the second device is worn by the user.

20. The method of claim 1 further comprising:
determining that the user is having difficulty hearing the audio source based on the sensor data; and
in accordance with determining that the user is having difficulty hearing the audio source, controlling provision of the audio signal from the audio source to the second device for audible presentation at the second device.

21. The method of claim 1, further comprising providing an indication of who is listening to audio produced by the audio source.

22. The method of claim 1, wherein the second device is the first device.

23. The method of claim 1, wherein the second device and first device are different devices.

24. A device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the one or more processors to perform operations comprising:
obtaining sensor data from one or more sensors in a physical environment, the physical environment comprising an audio source;
determining that an attention of a user of a second device is directed towards the audio source based on the sensor data; and
in accordance with determining that the attention of the user of the second device is directed towards the audio source, controlling provision of an audio signal from the audio source to the second device.

25. A non-transitory computer-readable storage medium, storing program instructions executable on a device to perform operations by one or more processors comprising:
obtaining sensor data from one or more sensors in a physical environment, the physical environment comprising an audio source;
determining that an attention of a user of a second device is directed towards the audio source based on the sensor data; and
in accordance with determining that the attention of the user of the second device is directed towards the audio source, controlling provision of an audio signal from the audio source to the second device.
